(19) United States
(12) Patent Application Publication
(10) Pub. No.: US 2010/0276238 A1
(43) Pub. Date: Nov. 4, 2010

(54) DEVICE FOR CONTROLLING A HYDRAULIC SUSPENSION SHOCK-ABSORBING DEVICE

(76) Inventor: Dominique Crasset, La Cour Marigny (FR)

Correspondence Address: LOWE HAUPTMAN HAM & BERNER, LLP, 1700 DIAGONAL ROAD, SUITE 300, ALEXANDRIA, VA, 22314, US

(21) Appl. No.: 12/682,107

(22) PCT Filed: Oct. 9, 2008
(86) PCT No.: PCT/FR2008/001413

§ 371 Date: Jul. 15, 2010

(30) Foreign Application Priority Data
Oct. 9, 2007 (FR) 07 07071

(51) Int. Cl. F16F 9/16

(52) U.S. Cl. 188/266.2

(57) ABSTRACT

The invention relates to a device for controlling a suspension hydraulic shock-absorbing device (2, 5) mounted on the frame (11) of a cycling vehicle, characterised in that the mobile wall of the piston (18) is provided with a valve, the opening of which is controlled by a cycling or tension detector (13) and controls the fluid flow from a chamber of the hydraulic portion to another one, and in that the valve is actuated by an actuation device attached to a cable (6) of the detector (13), the actuation device pivoting between a first valve-opening position and a second valve-closing position, the cable exiting its sheath at the level of a holder (43), wherein a compression spring (41) is positioned between the holder and the position for attaching the cable to the actuation device in order to resist the traction force of the cable on the actuation device, and returns the actuation device into a valve-opening position.

The present invention relates to the field of devices for suspension shock-absorbing devices and more particularly to the field of devices for controlling the functioning of suspension shock-absorbing devices of cyclist vehicles.

The patent FR 2809177 relates to a device associated with a pedalling effort or chain tension detector, the effort detector being positioned at the level of the crank gear of a cyclist vehicle. This effort detector connected to auto-regulating suspension controls and regulates the stiffness of the suspension by means of control means. As a function of detection undertaken at the level of the crank gear, displacement of the piston of the suspension shock-absorbing device can be blocked to facilitate pedalling by the cyclist. The control device of the functioning of the shock-absorbing device comprises regulation means of the passage of hydraulic fluid in a chamber of the shock-absorbing device in contact with compensation gas. This regulation is done by controlling the opening of an orifice by means of a valve formed by a cylinder mounted rotatively according to an axis perpendicular to the axis of the orifice, the cylinder comprising a bore perpendicular to its axis and aligned with the orifice which it regulates. Rotation of the cylinder causes the offset of its bore with the axis of the orifice and reduces or blocks the passage of fluid. This rotation is controlled from the detector by a cable connected to a lever mounted on the cylinder of the valve to the side of the shock-absorbing device and associated with at least one deformable elastic element mounted on the frame of the vehicle to enable the lever and the valve to return to a rest position. However, the disadvantages of such control device of a suspension shock-absorbing device are, on the one hand, an increase in the volume occupied by the shock-absorbing device by being positioned to the side of the shock-absorbing device and, on the other hand, being composed of different elements arranged respectively on different structures, complicating assembly operations of the device on the vehicle.

The aim of the present invention is to eliminate one or more disadvantages of the prior art and especially to propose a novel device for controlling a suspension shock-absorbing device whereof the assembly on the vehicle is facilitated and whereof the integration in some element of the shock-absorbing device reduces the volume occupied by the latter.

This objective is attained by a device for controlling a suspension shock-absorbing device mounted on the frame of a cyclist vehicle and controlled via at least one cable by a pedalling effort or chain tension detector mounted on a crank gear of the vehicle, a hydraulic suspension shock-absorbing device being mounted between at least two parts of the frame of the vehicle mounted mobile on one another and/or associated with a spring element mounted with the shock-absorbing device, the hydraulic shock-absorbing device comprising:
a volume fixed to a first of the two parts of the frame and integrating a hydraulic part with two chambers separated by the mobile wall of a piston having at least one orifice for the passage of fluid from one chamber to another,
gas separated from the hydraulic part by a mobile wall,
a rod of the piston whereof a first end is fixed to the mobile wall of the piston and whereof the second end is fixed on the second of the two parts of the frame,
   characterised in that the mobile wall of the piston is fitted with a valve whereof the opening, controlled by the pedalling effort or tension detector, manages the passage of fluid from one chamber of the hydraulic part to another,
   and in that the valve is actuated, at the level of the suspension shock-absorbing device, by an actuator whereof one end is fixed to the cable of the pedalling detector, the actuator moving between at least two positions, a first position opening the valve and a second position closing the valve during detection of determined pedalling effort, the cable of the detector coming out of its sheath at the level of a holder mounted on the suspension shock-absorbing device and/or on the frame of the vehicle, at least one elastic element is attached to the cable so as to oppose the traction force of the cable on the actuator, to allow antagonist action on traction of the cable and return to a position at least partially opening the valve and allowing the passage of fluid from one chamber to another.

According to a variant embodiment, the device for controlling a suspension shock-absorbing device is characterised in that the two positions limiting the amplitude of the functioning of the actuator are defined by stops arranged on the structure of the shock-absorbing device or an element of the shock-absorbing device to restrict on the one hand the displacement of at least one mobile element of the shock-absorbing device, and on the other hand the actuating amplitude of the pedalling effort detector.

According to another variant embodiment, the device for controlling a suspension shock-absorbing device is characterised in that the actuator comprises a lever pivoting between at least two positions, a first position opening the valve and a second position closing the valve during detection of determined pedalling effort, the cable of the detector coming out of its sheath at the level of a holder mounted on the suspension shock-absorbing device and/or on the frame of the vehicle, at least one elastic element opposing the traction force of the cable on the lever, to allow antagonist action on the traction of the cable on the lever and return to a position at least partially opening the valve and allowing the passage of fluid from one chamber to another.

According to another variant embodiment, the device for controlling a suspension shock-absorbing device is characterised in that, since the rod of the piston is hollow, the control device has a valve which comprises at least:
one first element hollow in length and positioned in the length of the hollow rod of the piston, fixed to the inner wall of the hollow rod of the piston and whereof extension into one of the chambers of the shock-absorbing device forms at least part of the mobile wall of the piston, this extension at the level of the mobile wall supporting at least one orifice for the passage of fluid from one chamber of the shock-absorbing device to another,
a second element positioned in the length and against the inner wall of the first hollow element, mounted mobile relative to the first hollow element so as to allow at least one axial rotation and/or axial translation according to the axis of the rod of the piston and of the two elements of the valve, and whereof extension into one of the chambers of the shock-absorbing device forms at least one part of the mobile wall of the piston and comprises at least one mobile orifice for controlling the passage of fluid from one chamber of the shock-absorbing device to another,
   such that sliding of the extension of the second valve element on the extension of the first valve element allows alignment or offset of the respective orifices for respectively enabling the passage of fluid from one chamber of the shock-absorbing device to another or blocking this passage.

According to another variant embodiment, the device for controlling a suspension shock-absorbing device is characterised in that at least one elastic element is positioned between the holder and at least one element of the actuator.

According to another variant embodiment, the device for controlling a suspension shock-absorbing device is characterised in that fixing of the sheath of the cable on the holder requires an element of adjustment of the position of the elastic element formed by a hollow threaded rod mounted in a tapped drilling of the holder and traversed by the cable, a end of the hollow threaded rod being supported against the end of an elastic element whereof the opposite end takes up an element fixed to the cable, the position of the hollow threaded rod in the tapped drilling being likely to be adjusted to define preloading of the force of the elastic element which opposes the tension of the cable on the lever.

According to another variant embodiment, the device for controlling a suspension shock-absorbing device is characterised in that at least one elastic element is positioned along the cabling which connects the pedalling effort detector to at least one element of the actuator of at least one suspension shock-absorbing device.

According to another variant embodiment, the device for controlling a suspension shock-absorbing device is characterised in that the cabling is formed by a first length of cable connected to the pedalling effort detector and at least one second length of cable connected to the actuator of at least one suspension shock-absorbing device, the first length of cable is connected with at least one second length of cable at the level of a crimping element mounted sliding in a cartridge mounted fixed with the sheath of the cabling, the elastic element being lodged in the cartridge between one end of the cartridge and the crimping element so as to oppose the traction force of the cable on the actuator.

According to another variant embodiment, the device for controlling a suspension shock-absorbing device is characterised in that the cartridge fixed to the sheath of the cabling is arranged such that its length can be adjusted so as to define preloading of the force of the elastic element which opposes the tension of the cable.

According to another variant embodiment, the device for controlling a suspension shock-absorbing device is characterised in that the crimping element connects the first length of cable, on the one hand, to a second length of cable for transmitting the action of the pedalling effort detector to at least one element of the actuator of a suspension shock-absorbing device mounted at a first point of the cyclist vehicle and, on the other hand, with a third length of cable for transmitting the action of the pedalling effort detector to at least one element of the actuator of a suspension shock-absorbing device mounted at a second point of the cyclist vehicle.

According to another variant embodiment, the device for controlling a suspension shock-absorbing device is characterised in that the device comprises at least two elastic elements, each having an end fixed at the level of the sliding crimping element,
a first elastic element, called “soft” and adapted to oppose the traction force of the cable on the actuator with a first resistance coefficient to compression and to allow return of the cable in the absence of traction on the cable, is positioned such that its second end is in direct or indirect support against one end of the cartridge and
a second elastic element, called “hard” and adapted to oppose the traction force of the cable on the actuator with a second resistance coefficient to compression, positioned such that its second end is free and is supported directly or indirectly against one end of the cartridge when the cable undergoes traction force.

According to another variant embodiment, the device for controlling a suspension shock-absorbing device is characterised in that since the cartridge is formed by a first semi-cartridge inserted in a second semi-cartridge, the device comprises a guide element of at least one bead lodged in a cavity of a face of the guide element, the guide element being mounted fixed pivoting and sliding in translation with a first semi-cartridge according to the axis of the cartridge and mobile pivoting with the second semi-cartridge such that the guide element pressurised by at least one elastic element against the inner end of the second semi-cartridge at the level of the face opposite the face which integrates the bead is held fixed in translation with the second semi-cartridge at the level of at least one bead which is positioned successively in a drill hole among a plurality of drill holes arranged circularly at the inner end of the semi-cartridge, during adjusting of preloading by pivoting one of the semi-cartridges relative to the other.

According to another variant embodiment, the device for controlling a suspension shock-absorbing device is characterised in that a torsion spring is positioned on the suspension shock-absorbing device with at least one of its ends mounted against a protrusion of the lever so as to oppose the traction force of the cable on the lever and allow the lever to return to a position allowing the passage of fluid from one chamber to another at the level of the piston.

According to another variant embodiment, the device for controlling a suspension shock-absorbing device is characterised in that the torsion spring is mounted wound about the end of the second valve element which exceeds the first valve element and the rod of the piston, a first end of the spring, mobile with the lever, is positioned against a protrusion of the lever and the second end, fixed relative to the structure of the suspension shock-absorbing device, is positioned and/or wedged and/or fixed against a holder formed by the structure of the shock-absorbing device.

According to another variant embodiment, the device for controlling a suspension shock-absorbing device is characterised in that the second end fixed of the torsion spring is supported against an adjustable element formed by a preloading screw positioned in the tapped drilling of a holder mounted on the structure of the shock-absorbing device and whereof one end of the preloading screw forms an adjustable stop to define the force of the torsion spring which opposes the tension of the cable on the lever.

According to another variant embodiment, the device for controlling a suspension shock-absorbing device is characterised in that the mobile wall of the piston comprises at least two superposed levels, a first level comprising at least one orifice associated with at least one check valve mounted spring-loaded and/or compressed for controlling respectively the phases of adjustment and/or compression of the shock-absorbing device and a second level comprising at least one orifice whereof the passage of fluid is controlled by the first and the second valve element.

According to another variant embodiment, the device for controlling a suspension shock-absorbing device is characterised in that the travel of the lever is pivoting in a plane substantially perpendicular to the axis of the rod of the piston and the elements of the valve and about a pivot, to which the lever is fixed, formed by the second valve element, the travel being limited by at least one stop mounted adjustable on an element of the structure of the shock-absorbing device defining a maximum and/or minimum threshold of travel which corresponds respectively to a position “of maximum tension of the cable” and/or to a position “of minimum tension of the cable”.

According to another variant embodiment, the device for controlling a suspension shock-absorbing device is characterised in that the travel of the lever is pivoting in a plane substantially parallel to the axis of the rod of the piston and elements of the valve, the pivot of the lever hinging with the second valve element via an angle return device and the travel being limited by at least one stop mounted adjustable on an element of the structure of the shock-absorbing device defining a maximum and/or minimum threshold of travel which corresponds respectively to a position “of maximum tension of the cable” and/or to a position “of minimum tension of the cable”.

According to another variant embodiment, the device for controlling a suspension shock-absorbing device is characterised in that the travel of the lever is pivoting in a plane substantially parallel to the axis of the rod of the piston and elements of the valve, and in that the end of the second valve element being fixed mobile to the lever, the cable is fixed on the lever at the level of a fixing point offset relative to the axis of translation of the second valve element such that the cable is not aligned with the axis of the elements of the valve, the cable and the second valve element now oriented in opposite directions on either side of the lever.

According to another variant embodiment, the device for controlling a suspension shock-absorbing device is characterised in that the second element being mobile in axial translation, a locking spring or a spring collar is mounted on the face of the piston opposite to the rod such that the end of the second mobile element of the valve is fixed to the centre of the spring collar and crushing of the spring collar generates opposition force to the tension force of the cable on the lever.

According to another variant embodiment, the device for controlling a suspension shock-absorbing device is characterised in that the cable of the detector exiting its sheath at the level of the suspension shock-absorbing device to be fixed at an end of the lever extends out of the shock-absorbing device to enter a new sheath and connect a second suspension shock-absorbing device of the vehicle, the ends of the sheaths at the level of the devices for shock-absorbing suspension devices being held in place by hollow threaded rods.

The invention, with its characteristics and advantages, will emerge more clearly from the following description given in reference to the attached diagrams, in which:

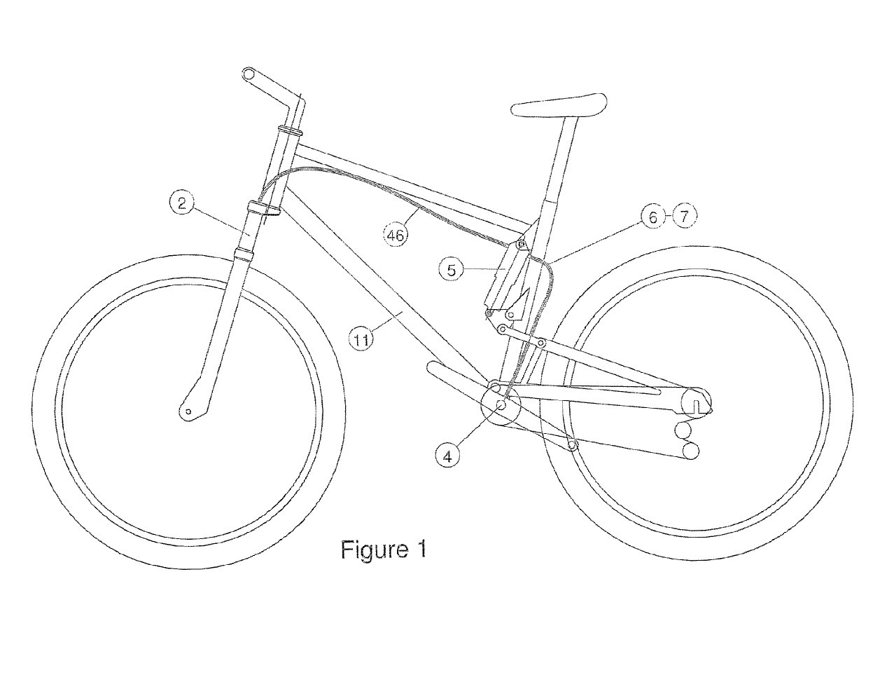

FIG. 1 schematically illustrates an example of a lateral view of a cyclist vehicle equipped with the regulation device of a suspension shock-absorbing device of the invention,

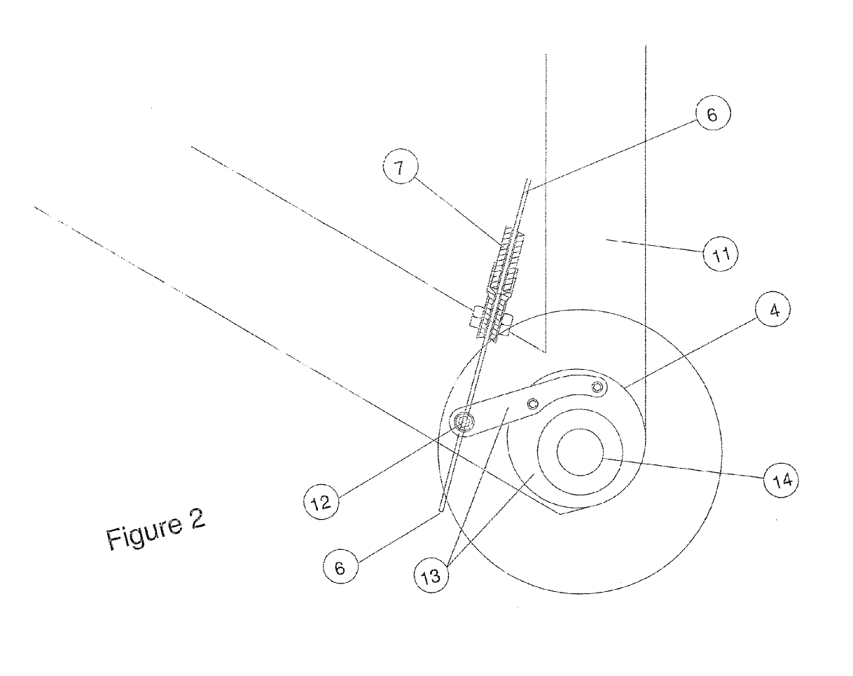

FIG. 2 schematically illustrates an example of a pedalling effort or chain tension detector device mounted on a crank gear of the vehicle,

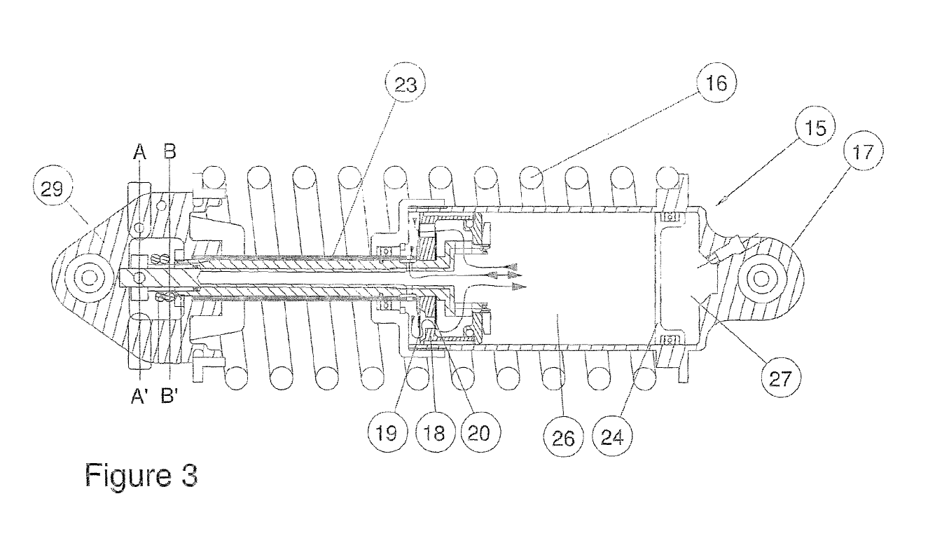

FIG. 3 schematically illustrates an example of a sectional view of a suspension shock-absorbing device,

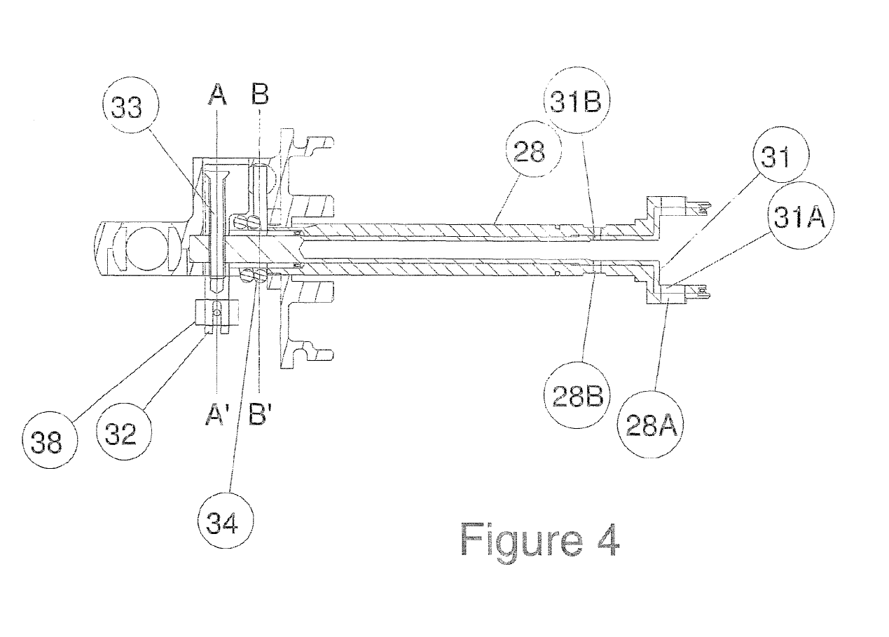

FIG. 4 schematically illustrates a view of a detail of the control device of the shock-absorbing device, the view being in section according to a plane passing through the axis of the shock-absorbing device and according to an angle of 90° relative to the section plane of FIG. 3,

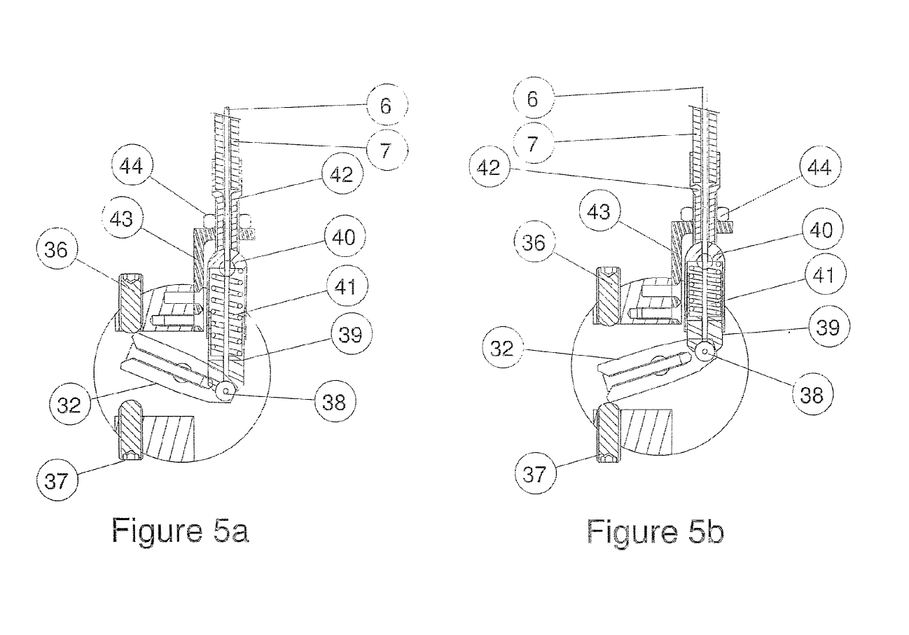

FIGS. 5a and 5b schematically illustrate an example of the functioning of the cable with the lever according to a view from one end of the shock-absorbing device of a section perpendicular to the axis of the shock-absorbing device and passing through the axis (AA′) of the lever,

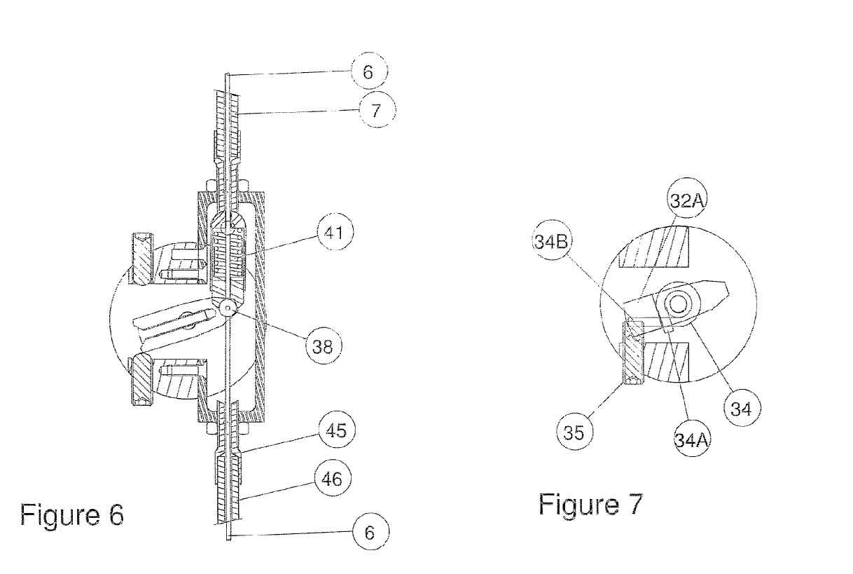

FIG. 6 schematically illustrates a variant embodiment of fixing of the cable on the lever, the cable participating in control of another shock-absorbing device,

FIG. 7 schematically illustrates a detail of the device in a bottom plan view of a section perpendicular to the axis of the shock-absorbing device and passing through the plane (BB′) of the torsion spring,

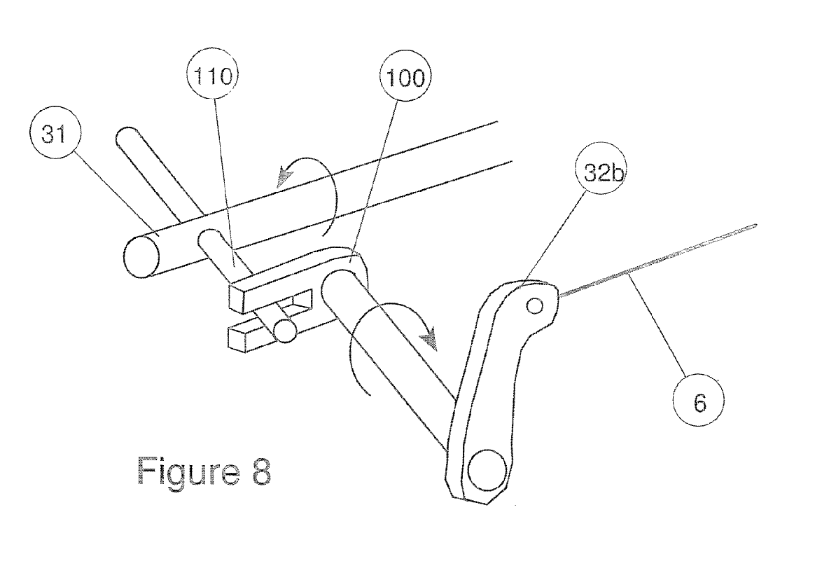

FIG. 8 schematically illustrates an example of a return angle device able to be used in the actuator of the invention,

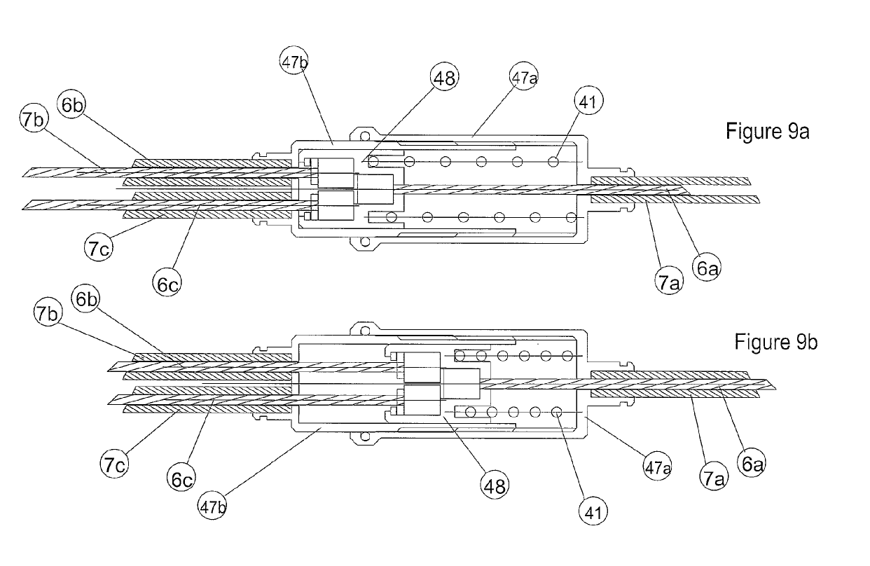

FIGS. 9a and 9b schematically illustrate an embodiment of a cartridge positioning elastic means on the actuation cabling of the shock-absorbing device, FIG. 9a having the elastic means in extension, FIG. 9b having the elastic means compressed,

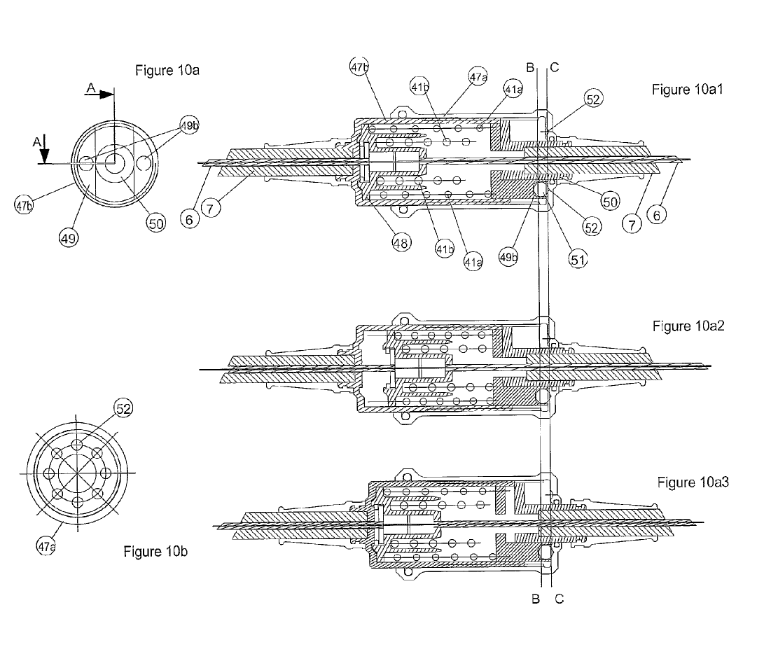

FIGS. 10a, 10a1, 10a2 and 10b schematically illustrate an embodiment of a cartridge integrating several elastic means on the actuation cabling of the shock-absorbing device and fitted with preloading adjusting means, in which:

FIG. 10a presents a section of the cartridge in a plane B perpendicular to the axis of the cartridge and passing through shoulders which bear the housing cavities for the beads,

FIGS. 10a1 and 10a2 present a projection plane of a section A-A of the cartridge passing through two planes perpendicular to each other and comprising the axis of the cartridge, the elastic means being respectively compressed and in extension,

FIG. 10a3 presents a projection of the cartridge similar to FIGS. 10a1 and 10a2, adjustment of the preloading being modified by decreases of the length of the cartridge,

FIG. 10b presents a section of the cartridge in a plane C perpendicular to the axis of the cartridge and passing through the drill holes of one of the semi-cartridges intended to receive a bead of the guide element.

The device of the invention relates to a device for controlling a suspension shock-absorbing device (2, 5) mounted on the frame of a cyclist vehicle. This control device is controlled by a cable (6) which slides in a sheath (7) mounted and stopped more or less directly on the frame (11) of the vehicle from a pedalling effort or chain tension detector (13) mounted on a particular crank gear (4) of the vehicle. Positioning of the cables (6) and their respective sheaths (7) on the frame (11) of the vehicle and/or at the level of at least one suspension shock-absorbing device is ensured by hollow threaded rods (42, 45) traversed by the cable (6) and whereof one end of the hollow threaded rod (42, 45) has an enlarged bore in which one end of the sheath (7) is positioned, the hollow threaded rod (42, 45) extending the sheath (7) in the cable guide (6). The hollow threaded rod (42, 45) is also kept in position on a holder element (43) of the suspension shock-absorbing device by a locknut (44).

The suspension shock-absorbing device (5) comprises a hydraulic shock-absorbing device (15) accompanied optionally by a helicoidal spring (16), the ends of each of these two elements (15, 16) fixed on parts of the frame (11) of the vehicle mounted mobile relative to one another, the parts of the frame (11) integrating at least one suspension element.

The hydraulic shock-absorbing device (15) comprises a first part which has a volume (17) forming the body of the shock-absorbing device (15), fixed to a first part of the frame of the vehicle, this volume (17) enclosing liquid fluid, for example oil, in which the mobile wall of a piston (18) is positioned which separates the volume (17) into two chambers. The mobile wall of the piston (18) is prolonged by a rod (23) which exits at the level of one of the ends of the volume (17) to then be fixed on the second part of the frame of the vehicle.

According to a particular embodiment, the volume (17) of the shock-absorbing device (15) also comprises a third chamber (27) comprising pressurised gas, positioned to the side opposite to the rod of the piston (18) and separated from one of the two chambers by a mobile sealed wall (24) to play a compensation function during displacement of the mobile wall of the piston (18) between the two fluid chambers.

The mobile wall of the piston (18) has at least one orifice for passage of fluid from one of the chambers to another, the opening of this orifice being controlled by a valve such that closing of the orifice by the valve prevents passage of the fluid from one chamber to another and blocks the sliding of the mobile wall of the piston (18) and therefore the functioning of the shock-absorbing device (15).

According to a particular embodiment, the mobile wall of the piston (18) comprises one or more check valves mounted spring-loaded (20) or compressed (19) on either side of at least one orifice of the mobile wall of the piston (18) so as to control respectively the release and compression phases of the shock-absorbing device. According to a preferred embodiment, the combination of these check valves (19, 20) with the valve of the device of the invention is done by a mobile wall of the piston (18) which has a first level comprising at least one orifice whereof the passage of fluid is managed by check valves (19, 20) superposed with a second level which comprises at least one orifice whereof the passage of fluid is controlled by the valve of the device of the invention.

The valve of the shock-absorbing device (15) comprises at least two elements (28, 31) positioned in the rod (23) of the piston (18), the rod (23) of the piston (18) forming a hollow conduit over its whole length. The first element (28) which makes up the body of the valve has a long-limbed structure which is positioned inside the rod (23) of the piston (18) such that its outer surface is affixed against the inner surface of the rod (23) of the piston (18), the outer diameter of the section of the valve body (28) being substantially identical to the inner diameter of the section of the rod (23) of the piston (18). One of the ends of the body of the valve (28) is prolonged and projects from the rod into the volume (17) of the shock-absorbing device (15) to rejoin and participate in formation of the mobile wall of the piston (18). At the level of this mobile wall, the valve body (28) has one or more orifices (28a) for the passage of fluid from one chamber of the volume to another. The first element (28) of the valve also forms a hollow conduit throughout its length and in which is positioned the second element (31) of the valve acting as the actual valve. While the first element (28) of the valve is mounted fixed relative to the rod (23) of the piston (18), the second element (31) is mounted mobile relative to the first element (28) of the valve and to the rod (23) of the piston (18) so as to produce axial rotation and/or axial translation according to the axis common to these three elements (23, 28, 31) inserted in each other. The second element (31) of the valve projects from the first element (28) and of the rod (23) at the level of each of its ends. At the level of the end which is located in the volume (17) of the shock-absorbing device (15) the extension of the second element (31) of the valve rejoins the mobile wall of the piston (18) and the surface of this extension is positioned against that of the extension of the first element (28) by having one or more orifices (31a) arranged relative to each other identically to those (28a) of the first element (28). Alignment or offset of the respective orifices (28a, 31a) of the first (28) and of the second (31) element ensures or blocks the passage of fluid from one chamber to the other of the volume (17) of the shock-absorbing device (15) of the piston. This alignment and/or this offset are ensured by displacement of the second element (31) relative to the first element (28) of the valve. This displacement is ensured by rotation and/or translation of the second element (31) on its axis.

According to a particular embodiment, the second element (31) of the valve also has a bore on part of its length so as to form a conduit which communicates with the chamber of the volume (17) which is opposite the rod (23) of the piston (18). At the level of its wall, this conduit comprises orifices (31b) which align with orifices (28b) arranged in the wall of the conduit of the first element (28) of the valve and of the rod (23) of the piston (18). When the device of the invention integrates check valves (19, 20) for control of release and compression phases of the shock-absorbing device, the fluid which passes through these orifices directly rejoins the chamber of the volume (17) opposite the rod (23) of the piston (18) without passing via the orifices managed by the check valves (19, 20).

The end of the second element (31) of the valve which exceeds the first element (28) of the valve of the side opposite the volume (17) of the shock-absorbing device (15) is fixed to a lever (32) arranged in a plane substantially perpendicular to the axis of the second element (31), such that travel of the lever (32) in its pivoting plane causes rotation of the second element (31) of the valve on its axis. This lever (32) forms for example an axial element mounted on the second valve element (31) at the level of a point arranged substantially at the centre of the axis. One of the ends of the lever (32) is fixed to the control cable (6) of the pedalling effort or chain tension detector (13) mounted on a particular crank gear (4) of the vehicle, tension on the cable (6) causing displacement of the second element (31) of the valve relative to the first element (28) and closing of the orifices of the mobile wall of the piston (18) for controlling, modulating or preventing the passage of the fluid of the piston (18) from one chamber to another.

Since the lever (32) is mounted on the end of the second element (31) of the valve such that the end of the second element (31) of the valve is inserted into a bore of the lever (32) perpendicular to the axis of the lever, fixing of the second valve element (31) on the lever (32) requires a screw (33) arranged in a bore of the lever (32) and according to the axis of the lever (32). During its positioning, this screw (33) passes through a bore situated at the end of the second element (31) of the valve mounted on the lever (32) reversibly connecting the second element (31) of the valve and the lever (32).

According to a variant embodiment, the lever is mounted pivoting in a plane substantially parallel to the axis of the shock-absorbing device. The lever is fixed on its pivot axis of the lever which is mounted mobile on a holder of the structure of the suspension shock-absorbing device (5) or of the frame, the pivot axis of the lever and the axis of the shock-absorbing device being substantially perpendicular to each other. One end of the pivot axis of the lever is articulated with the end of the second element (31) of the valve by requiring a return angle device, for example of conical pinion type. Pivoting of the lever on its axis causes axial rotation of the pivot axis of the lever and, via the return angle device, axial rotation of the second element (31) of the valve and thus occurs on the control of the valve.

By way of example, another return angle device can be made by a device requiring a U-shaped element (100) mounted pivoting at the level of its base in a plane substantially parallel to the axis of the elements (28, 31) of the valve, the pivot axis being common to the pivot axis of a lever whereof one end is fixed to the cable (6) of the pedalling effort or tension detector (13). The end of the second element (31) of the valve is traversed perpendicularly by an axis (110) whereof part is mobile between the two branches of the U-shaped element (100) mounted on the same axis as the lever, such that rotation of the lever causes pivoting of the U-shaped element (100) and such that the two branches of the U-shaped element (100) cause displacement of the axis (110) perpendicular to the second element (31) of the valve along these branches and/or pivoting of this axis about the axis of the second element (31) of the valve, such that this displacement causes rotation of the second element (31) of the valve on its axis. Stops are positioned, for example, on either side of the branches of the U-shaped element (100) to limit its pivoting range.

According to a particular feature of the valve, opening of the valve is conditioned by axial translation of the second element (31) relative to the first element (28). According to a simplified assembly, this translation can be controlled directly by the cable (6) which is fixed to the end of the second element (31) of the valve, traction of the cable (6) on the element (31) of the valve causing its translation and control of the valve. In this assembly, arrival of the cable (6) occurs in the axis of the shock-absorbing device. According to an improved assembly, the end of the second element (31) of the valve fixed to a lever is mounted in rotation in a plane substantially parallel to the axis of the shock-absorbing device, the axis of rotation of the lever being positioned in a plane substantially perpendicular to the axis of translation of the second element (31) of the valve. The cable (6) is fixed on the lever at the level of a fixing point offset relative to the axis of translation of the second element (31) such that the cable (6) is not aligned with the axis of the elements of the valve, the cable (6) and the second valve element being oriented in opposite directions on either side of the lever. This improved assembly dispenses with the problem posed by positioning of the sheath of the cable according to the axis of the shock-absorbing device at the level of the end of the shock-absorbing device fixed on the frame.

Fixing the cable (6) on the lever (32) requires a tightener (38). As it exits from the sheath (7) and the hollow threaded rod (42), the cable (6) passes through an elastic element, for example a compression spring (41), arranged between the lever (32) and the hollow threaded rod (42) mounted on a holder element of the shock-absorbing device (5). This elastic element (41) opposes the tension force exerted by the cable (6) of the detector (13) on the lever (32) and returns the lever (32) to a position “of minimum tension of the cable (6)”.

According to a particular embodiment, this elastic element (41) is positioned in a hollow volume, for example a cartridge, formed by two elements (39, 40) sliding in each other. A first element of the elements (40) of the volume is mounted at the level of one of its ends at the outlet of the hollow threaded rod (42), whereas due to the elastic element (41) arranged in the part hollow of the volume, the second element (39) which slides inside the first element (40) is stopped against an element fixed on the cable (6), for example a tightener fixed on the cable (6) to form a stop or else the tightener (38) fixes the cable (6) on the lever (32).

According to a particular embodiment, the two elements (39, 40) of the volume integrate at least one stop which limits compression of the elastic element (41) and therefore define the position of the lever (32) in a position “of maximum tension of the cable (6)”.

The positioning of the elastic element (41) on the device is not limited to alignment on the axis of the cable (6) but can be done between all points of the device where the elastic element (41) can oppose the tension force of the cable (6) on the lever and/or on the valve element in translation. Similarly, positioning of stops (36, 37) on the device to restrict the amplitude of displacement of one of the elements (28, 31) of the valve relative to the other can be done at any point of the device so as to occur on at least one of the mobile elements of the device. Positioning a stop can be done for example in the hollow part of the volume containing the elastic element (41). The effect of the stops (36, 37) on limitation of the amplitude of the action of the device also translates, via the cable (6), into limitation of actuating amplitude of the pedalling effort detector (13) which is more restricted.

According to a particular embodiment, the elastic element (41) is positioned along the cabling (6) which connects the pedalling effort detector (13) to an element of the actuator of a suspension shock-absorbing device as describes earlier. The cabling (6) is ensured by a first length of cable (6a) connected to the pedalling effort detector (13) and is connected to a second length of cable (6b) at the level of a crimping element (48). This second length of cable (6b) is connected to the suspension shock-absorbing device at the level of an element of the actuator. The effort made by the detector (13) on the cable (6a) is transmitted via the crimping element (48) and the second length of cable (6b) to rejoin the actuator of the shock-absorbing device. Each of the lengths (6a, 6b) of the cabling is arranged to slide in a length of sheath (7a, 7b) belonging to it. The crimping element (48) itself is arranged mobile and sliding in a cartridge (47) mounted fixed to the lengths (7a, 7b) of sheath of the cabling. The cartridge (47) has a substantially axial and elongated form such that a length of the cabling which passes through it can exit from it at each of the ends. The elastic element (41) is lodged inside the cartridge (47) so as to be positioned between one end of the cartridge (47) and the crimping element (48). The elastic element (41) is preferably positioned between the crimping element (48) and the end of the cartridge (47) where the length of cable (6a) connected to the detector (13) slides such that the elastic element (41) opposes the traction effort generated by the detector on the cable (6a).

According to a preferred embodiment, the cartridge (47) is arranged to be adjusted and define preloading of the force of the elastic element (41) which opposes the tension of the cable (6). An example of assembly consists of making the cartridge (47) from two semi-cartridges (47a, 47b) inserted tapped on its inner face in the other threaded on its outer face. The pivoting of one of the semi-cartridges about its axis relative to the other modifies the length of the cartridge (47) to adjust preloading of the force of the elastic element (41). Any other known system for modifying the length of the cartridge (47) can be used to modify and adjust preloading of the elastic element (41).

A particular embodiment of the cabling connects an extra length of cable (6c) to the crimping element (48) to actuate a second shock-absorbing device. This extra length of cable (6c) and its sheath (7c) are mounted in the cartridge (47) parallel to the length of cable (6b) which is connected between the crimping element (48) and the actuator of a first shock-absorbing device. The first and second shock-absorbing devices can be actuated concomitantly and, in parallel, by the detector (13) while being positioned at different points of the cyclist vehicle. This principle is not limited at a pair of shock-absorbing devices but can be adapted to a larger number.

According to another particular embodiment, the device of the invention comprises two elastic elements (41a, 41b) lodged in the cartridge (47). These elastic elements (41a, 41b) are preferably formed by a pair of helicoidal springs positioned coaxially along the axis of the cartridge (47). A first elastic element (41a) is positioned such that a first of its ends is supported against the crimping element (48) and the second end is supported against the inner end of the cartridge (47). The second elastic element (41b) is positioned such that a first of its ends is supported against the crimping element (48) and the second end is left free. This free end makes contact and is supported against the same inner end of the cartridge (47) as the first elastic element (41a) when the cable (6) undergoes traction force. The crushing of the second elastic element (41b) at the level of its second end inside the cartridge can occur directly or by means of one or more pieces (49, 50, 51) positioned between the free end of the elastic element (41b) and the interior of the cartridge (47).

FIGS. 10a and 10b show an embodiment wherein the first elastic element (41a) is formed by a helicoidal spring of greater diameter and greater length than the respective diameter and length of the spring which forms the second elastic element (41b). The first elastic element (41a) forms a spring, called “soft”, with less rigidity and greater deformation capacity than the second elastic element (41b) which forms a spring, called “hard”, these springs accordingly exhibiting different coefficients of resistance to compression during traction on the cabling (6). At rest, the first elastic element (41a) thrusts the crimping element (48) of the end of the cartridge (47) against which it is crushed when the cable (6) undergoes traction force. So, the first elastic element (41a) allows the cabling (6), on the one hand, to return to its position “of minimum tension of the cabling (6)”, in the absence of traction effort on the part of the detector (13) and, on the other hand, oppose or compensate a traction force on the cabling (6). The second elastic element (41b) acts when the cabling (6) undergoes stronger traction effort. Due to its shorter length, it acts only when traction on the cabling (6) exceeds a certain value. During progressive traction on the cabling (6), this difference in resistance coefficients to compression produces an opposition force to traction which is successively graduated to allow action at the level of the shock-absorbing device which is adapted to the extent of effort detected at the level of the crank gear. So, it is the projection by traction on the cabling (6) of a certain threshold value which actuates the second elastic element (41b) and enables a change in rigidity of the elastic system. According to a particular embodiment, the positioning and fixing of each of the springs forming the elastic elements (41a, 41b) on the crimping element (48) is carried out at the level of a respective circular throat. These circular throats are concentric, centred and coaxial to the axis of the cabling (6).

According to a particular embodiment of preloading adjustment since the cartridge is formed by a first threaded semi-cartridge (47b) inserted into a tapped second semi-cartridge (47a), the inner end of one (47a) of the semi-cartridges comprises a plurality of drill holes (52) arranged circularly and centred on the axis of the cable (6). Each of the drill holes (52) forms an increment in which a bead (51) guided by a guide element (49) is positioned during preloading adjustment. The depth of the drill hole is less than the diameter of the bead (51) so that the bead can be shifted from a first drill hole to an adjacent drill hole. The guide element (49) is formed by at least one piece traversed by a segment of the cable (6), mounted mobile in rotation and fixed in translation with the semi-cartridge (47a) which bears the plurality of drill holes (52) and mounted fixed in rotation and mobile in translation with the other semi-cartridge (47b) in which the crimping element (48) slides. This guide element (49) has at least one face with at least one cavity forming a housing (49b) for a bead (51). The depth of the cavity (49b) is less than the diameter of the bead but adequate for the bead (51) to remain held in its housing (49b), while only a spherical section of the bead (51) projects from the cavity (49b). Also, the cavity (49b) is arranged so as to be opposite to at least one drill hole (52) of the semi-cartridge (47a), while pivoting of a semi-cartridge (47b) about its axis relative to the other (47a) concomitantly pivots the guide element (49) about the axis of the cable (6) and moves the bead (51) from a first drill hole to an adjacent drill hole. The guide element (49) also has a face opposite to the face which bears the bead and in contact with at least one elastic element (41a, 41b). This face is intended to take up the pressure of at least one elastic element (41a, 41b) compressed by the cable (6) in traction. The elastic element keeps the guide element (49) fixed in translation with the semi-cartridge (47a) which bears the plurality of drill holes (52) and therefore the bead (51) against the inner end of the semi-cartridge (47a), concomitantly keeping the positioning of the bead in one of the drill holes in which it has been guided. With this device, during preloading adjustment, the length of the cartridge (47) is modified proportionally to compression of the elastic element (41) in a position “of minimum tension of the cable (6)” by rotation of the tapped semi-cartridge (47b) relative to the tapped semi-cartridge (47a). Also, rotation by increment, undertaken by successive positioning of the bead in one of the drill holes, generates clinking which increases along with compression of the elastic element (41) in a position “of minimum tension of the cable (6)” and therefore of preloading.

A particular embodiment for assembly of the guide element (49), so that it is, on the one hand, mobile in rotation and fixed in translation with the semi-cartridge (47a) which bears the plurality of drill holes (52) and, on the other hand, fixed in rotation and mobile in translation with the other semi-cartridge (47b), can consist of connecting it to an intermediate piece (50) fixed in rotation and in translation with the semi-cartridge (47b) in which the crimping element (48) slides. The guide element (49) is formed by a cylinder of diameter substantially identical to the inner diameter of the semi-cartridge (47b) in which the crimping element (48) slides and in which the guide element (49) is positioned loose. This guide element (49) comprises a recess over part of its length having the form of a planar section of a cylinder substantially forming a plane comprising the axis of the cylinder and centred on the axis of rotation of the guide element (49). On the guide element (49), the recess is open to the same face as the cavities (49b) of the housings of the beads (51). These cavities (49b) are borne by shoulders arranged on either side of the recess, that is, on the face opposite to the face intended to receive the pressure of an elastic element (41). The intermediate piece (50) interacts with the guide element (49) at the level of the its recess, at the level of at least one part of its body which has the form of a section of a cylinder adapted for insertion into the recess of the guide element (49) and of a diameter substantially identical to the inner diameter of the semi-cartridge (47a) which bears the plurality of drill holes (52). This intermediate piece (50) is fixed at the level of the part in the form of a section of a cylinder with the edge of the opening of the semi-cartridge (47b) in which the crimping element (48) slides. Affixing the intermediate piece (50) on the semi-cartridge (47b) leaves two openings in which the shoulders of the guide element (49) slide in translation, simultaneously blocking rotation of the guide element relative to the intermediate piece (50) and therefore to the semi-cartridge (47b). In this way, since the guide element (49) is already mobile in rotation and fixed in translation with the semi-cartridge (47a) which bears the plurality of drill holes (52), the intermediate piece (50) allows the guide element (49) to be mounted fixed in rotation and mobile in translation with the semi-cartridge (47b) in which the crimping element (48) slides. Also, the sheathing (7) of the cabling (6) is mounted on the intermediate piece such that since this intermediate piece (50) is, on the one hand, fixed to the semi-cartridge (47b) in which the crimping element (48) slides and which also bears the sheathing (7) and, on the other hand, is independent of the semi-cartridge (47a) which bears the drill holes (52), the preloading adjustment in modifying the length of the cartridge (47) does not generate modification in length on the sheathing (7) of the cabling (6).

The return of the lever (32) to a position “of minimum tension of the cable (6)” can also be ensured by an elastic element, for example a torsion spring (34). This spring (34) has at least one end (34a), mobile with the lever (32), supported against a protrusion (33a) of the lever (32) which permits return of the lever (32) to a position “of minimum tension of the cable (6)”.

According to a preferred embodiment, the torsion spring (34) has a circular part mounted about the end of the second element (31) of the valve, the end (34a), mobile, of the spring is then supported against a protrusion (32a) of the lever (32), while the other end (34b), fixed relative to the lever (32), is supported against an element of the structure of the shock-absorbing device (5).

According to a particular feature of the invention, the end (34b) is supported against an element of preloading adjustment (35) formed by a screw of adjustment positioned in the tapped drilling of a holder element mounted on the structure of the shock-absorber control device. One of the ends of the screw serves as stop for the end (34b) fixed of the spring (34) when the lever (32) reaches the position “of maximum tension of the cable (6)” to block the passage of liquid from one chamber to the other of the hydraulic shock-absorbing device (15). The preloading screw (35) is associated with hardness in the tapped drilling. The screw (35) has several striae arranged in its length and radially at regular intervals which interact with a bead mounted on a spring in a bore arranged substantially perpendicular to the axis of the tapped bore in which the preloading screw (35) is positioned. During screwing of the preloading screw (35) into the tapped drilling, the bead is positioned in the successive striae blocking the preloading screw (35) in a defined position. Also, the clinking of the bead on the successive striae during tightening of the screw (35) allows the user to evaluate preloading adjustment.

The travel of the lever (32) is limited by at least one stop, preferably two stops, a first stop (37) for a position “of maximum tension of the cable (6)” on the lever (32) and a second stop (36) for a position “of minimum tension of the cable (6)” on the lever (32), these positions corresponding at the level of the valve respectively to an offset position of the orifices of the first (28) and second (31) elements of the valve and to an alignment position of the first (28) and second (31) elements of the valve. These two stops (36, 37) are fixed on a holder element mounted on the suspension shock-absorbing device (5) and arranged on either side of at least one end of the lever (32), and preferably of the end of the lever (32) which is opposite the fixing point of the cable (6) on the lever (32) relative to the fixing point of the lever (32) on the second element (31) of the valve. These stops (36, 37) can be mounted adjustable by being formed by elements screwed on the holder element. This assembly can also require hardening such as for forming the preloading screw (35).

When the second element (31) of the valve is mobile in translation according to its axis, the opposition force to the tension force of the cable (6) on the lever or on the valve element in translation can be generated by a second elastic element formed by a locking spring or spring collar arranged at the level of the piston (18) of the shock-absorbing device, on the face of the piston (18) opposite the rod (23). The mobile end of the second element (31) of the valve is fixed to the centre of the spring collar such that tension of the cable (6) causes translation of the valve element and crushing of the spring collar on the surface of the piston (18). According to a particular embodiment, the crushing of the spring collar on the surface of the piston allows the washer to totally or partially cover at least release (20) or compression (19) check valve and reinforce its functioning.

According to a particular embodiment, the cable (6) controlled by the detector (13) controls the suspension shock-absorbing device (5) mounted on the frame of the vehicle, but also a second suspension shock-absorbing device (2) mounted for example on the fork of the vehicle. To achieve this, beyond the fixing point of the cable (6) on the end of the lever (32), the cable (6) is extended towards a hollow threaded rod (45) which positions a new sheath (46) leading to the second suspension shock-absorbing device (2). According to a variant embodiment, the cable (6) is extended, beyond its fixing point on the lever, by a second cable which is designed for activation of the second shock-absorbing device (2).

It must be evident for the person skilled in the art that the present invention allows embodiments in numerous other specific forms without departing from the field of application of the invention as claimed. Consequently, the present embodiments must be considered by way of illustration but can be modified in the field defined by the scope of the attached claims.

1. A device for control of a suspension shock-absorbing device mounted on the frame of a cyclist vehicle and controlled via at least one cable by a pedalling effort or chain tension detector mounted on a crank gear of the vehicle, a hydraulic suspension shock-absorbing device being mounted between at least two parts of the frame of the vehicle mounted mobile to each other and/or associated with a spring element mounted with the shock-absorbing device, the hydraulic shock-absorbing device comprising:
a volume fixed to a first of two parts of the frame and integrating a hydraulic part with two chambers separated by the mobile wall of a piston having at least one orifice for the passage of fluid from one chamber to another,
a rod of the piston whereof a first end is fixed to the mobile wall of the piston and whereof the second end is fixed on the second of the two parts of the frame,
wherein the mobile wall of the piston is fitted with a valve whereof the opening, controlled by the pedalling effort or tension detector, configured to manage the passage of fluid from one chamber of the hydraulic part to another,
and in that the valve is configured to be actuated, at the level of the suspension shock-absorbing device, by an actuator whereof one end is fixed to the cable of the pedalling detector, the actuator configured to move between at least two positions, a first position in which the valve is open and a second position in which the valve is closed responsive to detection of pedalling effort, the cable of the detector configured to come out of its sheath at the level of a holder mounted on the suspension shock-absorbing device and/or on the frame of the vehicle, at least one elastic element attached to the cable so as to oppose the traction force of the cable on the actuator to enable counteraction to traction of the cable and configured to return to a position at least partially opening the valve and to allow the passage of fluid from one chamber to another.

2. The device for controlling a suspension shock-absorbing device as claimed in claim 1, the two positions which limit the amplitude of the functioning of the actuator being defined by stops arranged on the structure of the shock-absorbing device or an element of the shock-absorbing device to, on the one hand, restrict displacement of at least one mobile element of the shock-absorbing device and, on the other hand, the actuate amplitude of the pedalling effort detector.

3. The device for controlling a suspension shock-absorbing device as claimed in claim 1, actuator comprising a lever configured to pivot between at least two positions, a first position opening the valve and a second position closing the valve responsive to detection of pedalling effort, the cable of the detector configured to come out of its sheath at the level of a holder mounted on the suspension shock-absorbing device and/or on the frame of the vehicle, at least one elastic element configured to oppose the traction force of the cable on the lever, to enable counteraction to traction of the cable on the lever and configured to return to a position at least partially opening the valve and allow the passage of fluid from one chamber to another.

4. The device for controlling a suspension shock-absorbing device as claimed in claim 1, the rod of the piston being hollow, the control device having a valve which comprises at least:
a first hollow element in its length and positioned in the length of the hollow rod of the piston, fixed to the inner wall of the hollow rod of the piston and whereof extension in one of the chambers of the shock-absorbing device is configured to form at least part of the mobile wall of the piston, the extension at the level of the mobile wall supporting at least one orifice for passage of fluid from one chamber of the shock-absorbing device to another,
a second element positioned in the length and against the inner wall of the first hollow element, mounted mobile relative to the first hollow element so as to allow at least axial rotation and/or axial translation according to the axis of the rod of the piston and of the two elements of the valve, and whereof extension into one of the chambers of the shock-absorbing device is configured to form at least part of the mobile wall of the piston and comprises at least one mobile orifice configured to control the passage of fluid from one chamber of the shock-absorbing device to another,
the second element of the valve being configured with respect to the first element of the valve such that sliding of the extension of the second element of the valve on the extension of the first element of the valve allows alignment or offset of the respective orifices for respectively enabling the passage of fluid from one chamber of the shock-absorbing device to another or blocking the passage of fluid.

5. The device for controlling a suspension shock-absorbing device as claimed in claim 1, at least one elastic element positioned between the holder and at least one element of the actuator.

6. The device for controlling a suspension shock-absorbing device as claimed in claim 5, fixing of the sheath of the cable on the holder requiring an adjustment element of the position of the elastic element formed by a hollow threaded rod mounted in a tapped drilling of the holder and traversed by the cable, an end of the hollow threaded rod supported against the end of an elastic element whereof the opposite end receives an element fixed to the cable, the position of the hollow threaded rod in the tapped drilling being capable of being adjusted to define preloading of the force of the elastic element which opposes the tension of the cable on the lever.

7. The device for controlling a suspension shock-absorbing device as claimed in claim 1, at least one elastic element positioned along the cabling which connects the pedalling effort detector to at least one element of the actuator of at least one suspension shock-absorbing device.

8. The device for controlling a suspension shock-absorbing device as claimed in claim 7, the cabling formed by a first length of cable connected to the pedalling effort detector and at least one second length of cable connected to the actuator of at least one suspension shock-absorbing device, the first length of cable connected with at least one second length of cable at the level of a crimping element mounted sliding in a cartridge mounted fixed with the sheath of the cabling, the elastic element being lodged in the cartridge between one end of the cartridge and the crimping element so as to oppose the traction force of the cable on the actuator.

9. The device for controlling a suspension shock-absorbing device as claimed in claim 7, the cartridge fixed to the sheath of the cabling arranged such that its length can be adjusted so as to define preloading of the force of the elastic element which opposes the tension of the cable.

10. The device for controlling a suspension shock-absorbing device as claimed in claim 7, the crimping element connecting the first length of cable, on the one hand, to a second length of cable and arranged to transmit the action of the pedalling effort detector to at least one element of the actuator of a suspension shock-absorbing device mounted at a first point on the cyclist vehicle and, on the other hand, to a third length of cable and arranged to transmit the action of the pedalling effort detector to at least one element of the actuator of a suspension shock-absorbing device mounted at a second point of the cyclist vehicle.

11. The device for controlling a suspension shock-absorbing device as claimed in claim 8, the device comprising at least two elastic elements, each having an end fixed at the level of the crimping element sliding,
a first elastic element, adapted to oppose the traction force of the cable on the actuator with a first resistance coefficient to compression and allowing return of the cable in the absence of traction on the cable, positioned such that its second end is in direct or indirect support against one end of the cartridge and
a second elastic element, adapted to oppose the traction force of the cable on the actuator with a second resistance coefficient to compression, positioned such that its second end is free and supported directly or indirectly against one end of the cartridge when the cable undergoes traction force.

12. The device for controlling a suspension shock-absorbing device as claimed in claim 9, the cartridge formed by a first semi-cartridge inserted in a second semi-cartridge, the device comprising a guide element of at least one bead lodged in a cavity of a face of the guide element, the guide element being mounted fixed pivoting and sliding in translation with a first semi-cartridge according to the axis of the cartridge and mobile pivoting with the second semi-cartridge such that the guide element pressurised by at least one elastic element against the inner end of the second semi-cartridge at the level of the face opposite the face which integrates the bead is held fixed in translation with the second semi-cartridge at the level of at least one bead which is positioned successively in one drill hole of a plurality of drill holes arranged circularly at the inner end of the semi-cartridge, during adjusting of preloading by pivoting one of the semi-cartridges relative to the other.

13. The device for controlling a suspension shock-absorbing device as claimed in claim 1, a torsion spring positioned on the suspension shock-absorbing device with at least one of its ends mounted against a protrusion of the lever so as to oppose the traction force of the cable on the lever and configured to allow the lever to return to a position allowing at the level of the piston the passage of fluid from one chamber to another.

14. The device for controlling a suspension shock-absorbing device as claimed in claim 11, the torsion spring mounted wound about the end of the second element of the valve which exceeds the first element of the valve and of the rod of the piston, a first end of the spring, mobile with the lever, positioned against a protrusion of the lever and the second end, fixed relative to the structure of the suspension shock-absorbing device positioned and/or wedged and/or fixed against a holder formed by the structure of the shock-absorbing device.

15. The device for controlling a suspension shock-absorbing device as claimed in claim 11, the second end fixed of the torsion spring supported against an adjustable element formed by a preloading screw positioned in the tapped drilling of a holder mounted on the structure of the shock-absorbing device and whereof one end of the preloading screw forms an adjustable stop for defining the force of the torsion spring which opposes the tension of the cable on the lever.

16. The device for controlling a suspension shock-absorbing device as claimed in claim 1, the mobile wall of the piston comprising at least two superposed levels, a first level comprising at least one orifice associated with at least one check valve mounted spring-loaded and/or compressed for controlling respectively the release and/or compression phases of the shock-absorbing device and a second level comprising at least one orifice whereof the passage of fluid is controlled by the first and the second valve element.

17. The device for controlling a suspension shock-absorbing device as claimed in claim 5, the travel of the lever is configured to pivot in a plane substantially perpendicular to the axis of the rod of the piston and elements of the valve and about a pivot, to which the lever is fixed, formed by the second element of the valve, the travel being limited by at least one stop mounted adjustable on an element of the structure of the shock-absorbing device defining a maximum and/or minimum threshold of travel which corresponds respectively to a position of maximum tension of the cable and/or to a position of minimum tension of the cable.

18. The device for controlling a suspension shock-absorbing device as claimed in claim 5, the travel of the lever is configured to pivot in a plane substantially parallel to the axis of the rod of the piston and elements of the valve, the pivot of the lever articulating with the second element of the valve by a return angle device and travel being limited by at least one stop mounted adjustable on an element of the structure of the shock-absorbing device defining a maximum and/or minimum threshold of travel which corresponds respectively to a position of maximum tension of the cable and/or to a position of minimum tension of the cable.

19. The device for controlling a suspension shock-absorbing device as claimed in claim 5, the travel of the lever is configured to pivot in a plane substantially parallel to the axis of the rod of the piston and elements of the valve, and in that, since the end of the second element of the valve is fixed mobile to the lever, the cable being fixed on the lever at the level of a fixing point offset relative to the axis of translation of the second element of the valve such that the cable is not aligned with the axis of the elements of the valve, the cable and the second valve element is oriented in opposite directions on either side of the lever.

20. The device for controlling a suspension shock-absorbing device as claimed in claim 5, the second element is mobile in axial translation, a locking spring or a spring collar is mounted on the face of the piston opposite the rod such that the end of the second mobile element of the valve is fixed to the centre of the spring collar and in that crushing of the spring collar generates opposition force to the tension force of the cable on the lever.

21. The device for controlling a suspension shock-absorbing device as claimed in claim 5, the cable of the detector is configured to exit its sheath at the level of the suspension shock-absorbing device to be fixed at an end of the lever extending out of the shock-absorbing device to enter a new sheath and rejoin a second suspension shock-absorbing device of the vehicle, the ends of the sheaths at the level of the devices for shock-absorbing suspension devices being held in place by hollow threaded rods.
